(19) United States
(12) Patent Application Publication
(10) Pub. No.: US 2004/0030697 A1
(43) Pub. Date: Feb. 12, 2004

(54) System and method for online feedback

(75) Inventors: Thomas Eric Cochran, Vienna, VA (US); Matthew Todd Richards, Cambridge, MA (US); Kevin Tzu-Hao Fine, Burke, VA (US); Jedidiah Eli Fonner, Silver Spring, MD (US)

Correspondence Address: STAAS & HALSEY LLP, SUITE 700, 1201 NEW YORK AVENUE, N.W., WASHINGTON, DC, 20005, US

(73) Assignee: American Management Systems, Inc.

(21) Appl. No.: 10/208,020

(22) Filed: Jul. 31, 2002

(51) Int. Cl. G06F 17/30

(52) U.S. Cl. 707/9

(57) ABSTRACT

The present invention relates to a feedback system for adding feedback functionality to an online content management system without altering the stored online content. The feedback system includes a feedback submission module for providing the content system with information enabling a browser displaying hypertext received from the content management system to select text for specific commenting, providing a feedback form when a portion of the hypertext is highlighted, and storing the selected text along with feedback received with the feedback form after it is returned by the browser. The system may include a personalized feedback status module, a view feedback module, and a feedback management module. The personalized feedback status module: responds to a user request to view feedback submitted by a user by searching the stored feedback; sends results to the browser. The view feedback module: responds to a command from the browser to view feedback stored in the feedback system by sending a search form to the browser, in which a user can enter or select search criteria; responds to return of the search form by applying user-defined search criteria to filter previous feedback entries stored by the feedback system and return the resulting entries to the user's browser for review. The feedback management module enables an administrator to use a browser to review, comment on, and change the approval status, edit, or logically delete feedback entries stored by the feedback system.

### CROSS-REFERENCE TO RELATED APPLICATION

This application is related to application entitled “Content Management System” having serial number 6,356,903, filed Dec. 30, 1998, and incorporated by reference herein.

### BACKGROUND OF THE INVENTION

1. Field of the Invention

The present invention is directed to a system for providing and managing feedback directed to online content.

2. Description of the Related Art

Hypertext servers and browsers, as for example Hypertext Transfer Protocol (HTTP) web servers and web browsers are known in the art. Web servers are used to provide online access to documents by sending the documents as hypertext to the web browsers. Generally, because web browsers are not able to modify or edit online hypertext documents or online content, systems for providing feedback or comments directed to online content or hypertext documents have been limited.

Previously, users browsing online content or hypertext documents could comment on the documents by invoking a feedback link in the document. In response, the hypertext or web server would return a form, which the user would fill out and return to the server. The server would store the comment, and sometimes would associate the comment with the web page. Another approach for enabling comment submission has been to respond to a request to submit comments by initiating an e-mail process to enter the comments and then send them by e-mail.

These prior approaches have drawbacks and limitations. When a hypertext document is long, comments cannot be directed to or automatically associated with a specific portion of the document. A person responsible for the content of the commented-on document cannot review comments with any granularity, and the context of the comment is not apparent because the comment is at best associated with the whole document or online content in its entirety. Furthermore, a person submitting a comment would not be able to view, manage, or follow the status of the comments that they have submitted.

What is needed is a system that facilitates online submission and management of feedback.

### SUMMARY OF THE INVENTION

It is an aspect of the present invention to provide a system that automatically captures a portion of browsable content that has been selected for receiving a selection-specific comment or feedback.

It is another aspect of the present invention to provide a system that automatically includes the captured data in an online feedback form.

It is also an aspect of the present invention to provide a system in which a user who has submitted feedback may view the comments that they have previously submitted and the status of their comments.

It is a further aspect of the present invention to provide a feedback mechanism that enables a user to view previous feedback submissions with a web browser, based on comment-search criteria entered by the user.

It is a still further aspect of the present invention to provide a hypertext-based feedback system that enables a user to use a hypertext browser to view comments based on comment-search criteria entered by the user.

It is an aspect of the present invention to provide a hypertext-based feedback system that enables an administrator to administer a database of comments using a hypertext browser.

It is a further aspect of the present invention to provide a hypertext-based feedback system that enables recursive online commenting, where comments may be directed to previously submitted comments.

It is another aspect of the present invention to provide a hypertext-based feedback system that automatically notifies an author or person responsible for a document that a comment directed to the document or portion thereof has been submitted.

The above aspects can be attained by a system for interactively selecting a portion of hypertext displayed in a hypertext browser; interactively inputting feedback related to the portion; and automatically storing, apart from the hypertext, information associating the feedback with the selected portion.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows the association of feedback with a portion of a document.

FIG. 2 shows a preferred embodiment of a hardware arrangement for implementing the present invention.

FIG. 3 shows a process of document generation.

FIG. 4 shows a general feedback processing sequence.

FIG. 5 shows another feedback processing sequence.

FIG. 6 shows a more detailed feedback process.

FIG. 7 shows a high-level diagram of interactions between modules in an embodiment of the present invention.

FIG. 8 shows a more detailed view of the interactions shown in FIG. 7.

FIG. 9 shows a process flow of the send feedback module 140.

FIG. 10 shows another aspect of the process of the send feedback module 140.

FIG. 11 shows a process of the view feedback module 142.

FIG. 12 shows other details of the process by which a user can view previous feedback submissions held in the feedback database 38.

FIG. 13 shows a process of the my-feedback-status module 144.

FIG. 14 shows other details of the process by which a user can get information about feedback that they previously submitted.

FIG. 15 shows a process carried out by the feedback administration module 146.

FIG. 16 shows another aspect of the process of the feedback administration module 146.

FIGS. 17-25 show user interface screens for entering feedback.

FIG. 17 shows a simple document 12 from the document base 34 as it would be displayed without the feedback system.

FIG. 18 shows the document 12 as displayed in the feedback system. The feedback system adds the interface objects 360.

FIG. 19 shows a portion of the document 14 that has been highlighted by the user.

FIG. 20 shows a menu 362 popped up by for example right-clicking on the document 12.

FIG. 21 shows the “Send Feedback” menu item 364 being selected to initiate the send feedback process.

FIG. 22 shows the submit feedback form 16 in which the selected text 14 has been automatically incorporated.

FIG. 23 shows data entered in the submit feedback form 16, including the feedback comment 18.

FIG. 24 shows a page 366 displayed in response to the successful submission of the form 16 shown in FIG. 24.

FIG. 25 shows the commented-on document 12 and a “view comments” widget 370.

FIG. 26 shows a pull-down menu 374.

FIG. 27 shows a page 380 displayed in response to requesting to “view comments” specific to a document.

FIG. 28 shows an example of a “my feedback” form 390 used to enter 292 the email address of the user.

FIG. 29 shows an email address entered in the form 390.

FIG. 30 shows a search result page 400 returned after submitting the “my feedback” form 390.

FIG. 31 shows an example of a “view feedback” result page 410 resulting from a “view feedback” search 254.

FIG. 32 shows a feedback mirroring arrangement.

### DETAILED DESCRIPTION OF THE PREFERRED EMBODIMENTS

Process Overview

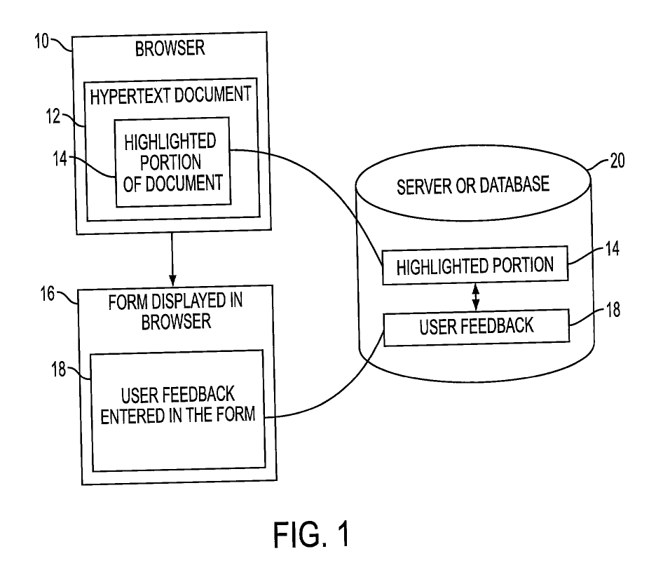

FIGS. 1-6 are referred to describe an overview of the feedback process.

FIG. 1 shows the association of feedback with a portion of a document. Initially, a browser 10 displays a hypertext document 12. A portion 14 of the document 12 is interactively selected or highlighted. After the user informs the browser 10 that the user intends to submit feedback related to the portion 14, a form 16 is displayed in the browser 10. The user enters feedback 18 into the form 16. The feedback 18 is stored at a server or in a database 20, where it is automatically associated with a reference to or a copy of the portion 14. The invention is applicable to all forms of online browsable documents or content, where “content” is defined to include at least hypertext, HTML, hypercontent, non-text or binary media, and other content that is received over a network for browsing, and which may include hyperlinks to other content. The term “browser” is defined to include hypertext browsers (e.g. Internet Explorer), but is not so limited, and also includes any software or devices for browsing online content. “Feedback” and “comment” are used interchangeably in this detailed description. The term “hypertext” is defined, to include any hyperlinked text, and is not limited to HTML form.

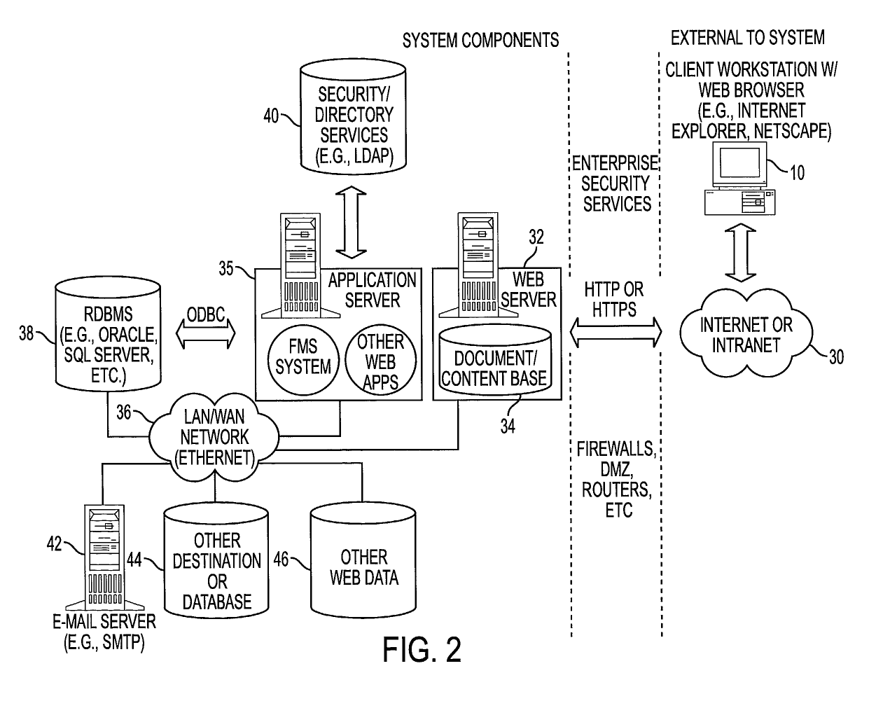

FIG. 2 shows a preferred embodiment of a hardware arrangement for implementing the present invention. A web browser 10 communicates over a network 30 with a web server 32. The web server 32 serves content such as hypertext documents in a document base 34 to the web browser 10. The web server 32 and web browser 10 are typically arranged. Standard components known in the art may be used for the web server 32 and the browser 10, which may be, for example, the Apache Web Server and Microsoft's Internet Explorer. Content can also be managed by a content management system, as described in U.S. Pat. No. 6,356,903.

Feedback functionality is provided by the addition of an application server 35 that communicates with the web server 32. The application server 35 communicates over a LAN 36 with a database server 38 using a database connectivity protocol, such as the Open Database Connection (ODBC) protocol. When requested by the web server 20, the application server 35 provides the web server 20 with the necessary feedback functionality. As discussed further below, the system may also make use of other components, such as a directory service 40, an e-mail server 42, or other databases 44, 46. The Lightweight Directory Access Protocol (LDAP) may be used to access the directory service 40. Different permutations and arrangements are also possible. For example, all functionality may be located on a single server, or may be distributed across different servers providing segmented or parallel service. Because of the possible variations, server-side activity will be referred to hereafter as simply occurring at “the server”, which is applicable to either single-server or multiple server arrangements.

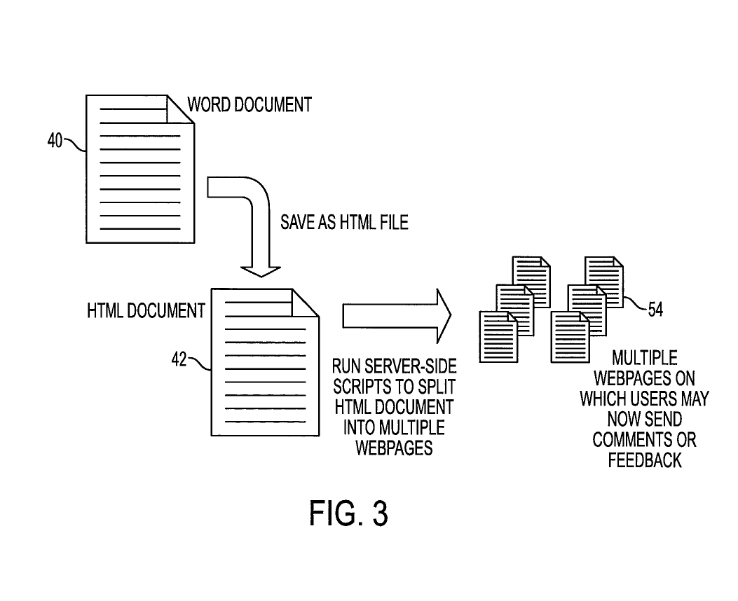

FIG. 3 shows a process of document generation. Documents 40 for the document base 34 are preferably generated by saving word processing documents (e.g., Microsoft Word format) as HTML files 42 and applying server-side scripts (e.g., PHP) to parse through and split the larger source documents into numerous smaller files to be served as web pages 54. In typical fashion, these web pages 54 are served upon request to the web browser 10.

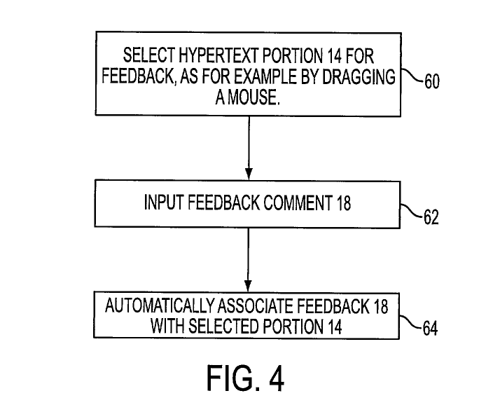

FIG. 4 shows a general feedback processing sequence. After the web browser 10 has displayed one of the content base's 34 web pages 54 received from the web server 20, a user interactively selects 60 the hypertext portion 14 for feedback, as for example by dragging a mouse and highlighting desired content. The user then inputs 62 a feedback comment 18 that is directed to the selected portion 14. The feedback 18 is then automatically associated 64 with the selected portion 14.

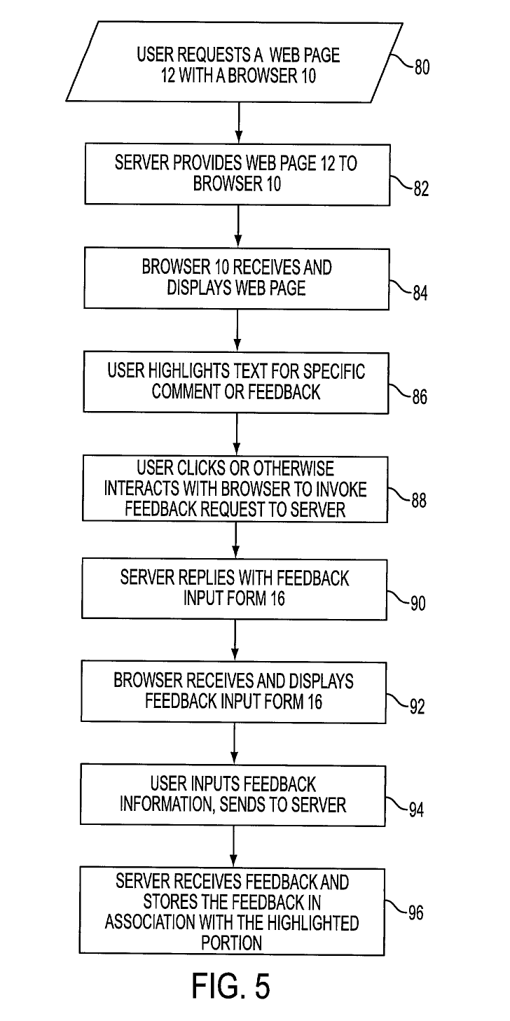

FIG. 5 shows another feedback processing sequence. Initially, a user requests 80 a web page 12 with a browser 10. A server provides 82 the web page 12 to the browser 10. The browser 10 receives and displays 84 the web page 12. The user then highlights 86 text or displayed portion 14 for specific comment or feedback. The user then clicks or otherwise interacts with the browser 10 to send a feedback request or command to the server. The server replies 90 by returning to the browser 10 a feedback input form 16, which the browser receives and displays 92. The user inputs 62/94 feedback information 18 into the displayed form 16, for example by typing in text. The server then receives 96 the feedback information 18, and stores the feedback in association with the highlighted portion 14.

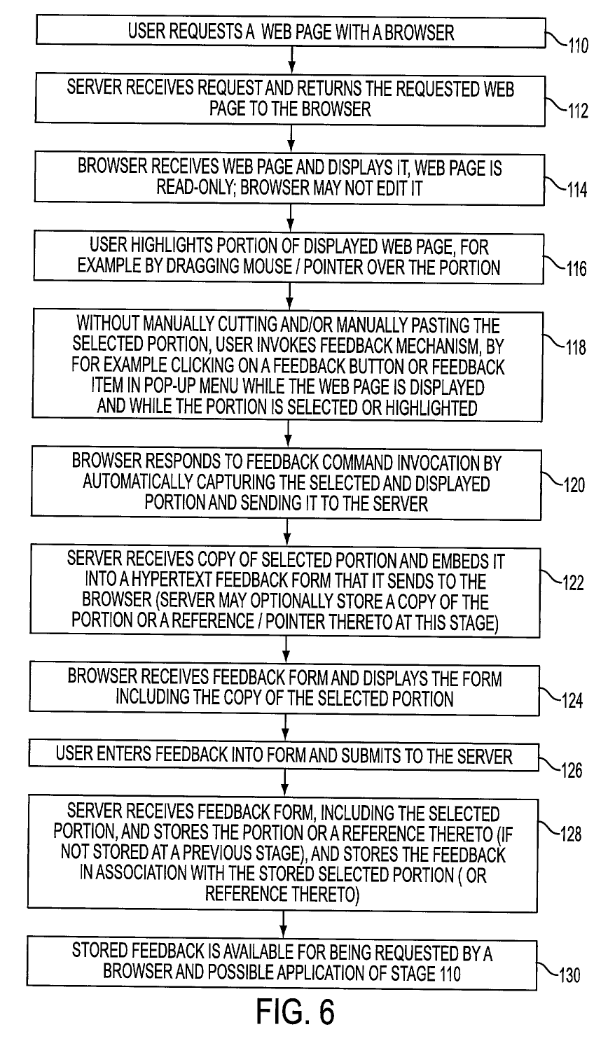

FIG. 6 shows a more detailed feedback process. Initially, the user requests 110 a web page using a web browser. A web server receives 112 the request and returns the requested web page to the browser. The web browser then receives the web page and displays 114 it in the read-only fashion typical of web browsers; the browser may not be used to directly alter the web page as it is stored at the web server. The user highlights 116 a portion of the displayed web page. Without manually cutting and/or manually pasting the highlighted portion, the user invokes 118 a feedback mechanism, for example, by clicking on a feedback button or a pop-up menu while the web page is displayed and while the portion is selected or highlighted. The browser responds to the feedback command invocation by automatically capturing 120 the selected and displayed portion and sending it to the server. The server receives the captured copy via an HTTP post variables method and embeds 122 it into a hypertext feedback form that it sends to the browser. Other approaches of making the captured copy part of the feedback system are also possible. For example, the server could optionally store the copy of the automatically captured portion (or a reference or pointer thereto), which may be later associated with feedback. In the alternative, the server may place the portion into a hypertext session or state variable (as in a hidden field) or a cookie, which may then be returned to the browser. Preferably, though, the server does not store or commit the captured portion until the entire feedback form is validated and submitted.

The browser receives the feedback form and displays 124 the feedback form. Preferably, the display 124 of the feedback form also displays the copy of the selected portion, or information reflective of the selected portion, as for example an abbreviation or sub-portion of the portion may be displayed. The user enters feedback into the form and submits 126 the form to the server. The entered feedback can be in any form, such as a drawing, image, text, etc. but is preferably textual. The server receives the submitted 126 form (or a transmission of the information entered in the form), and stores 128 the feedback in association with the stored selected portion (or reference thereto). At this point, the stored feedback is now available as content that can be requested by a browser at a later pass of the request stage 110. Because the stored feedback is available 130 to be requested 110, displayed 114 at the browser, and so on, it is apparent that the feedback itself may be commented upon using the same process that generated it. In this sense, the present invention, in one aspect, is capable of providing recursive feedback commentary, with which users may carry on a dialog that is rooted in or based on the underlying documents and initiated by a primary or initial comment submission.

Modular Embodiments of the Above-Discussed Processes

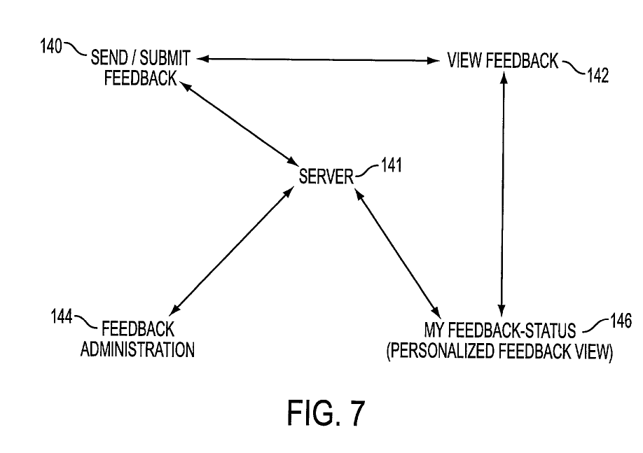

FIGS. 1-6 were referred to above in describing an overall process of the present invention. FIGS. 7-16 are referred to below in describing a modular aspect of the present invention.

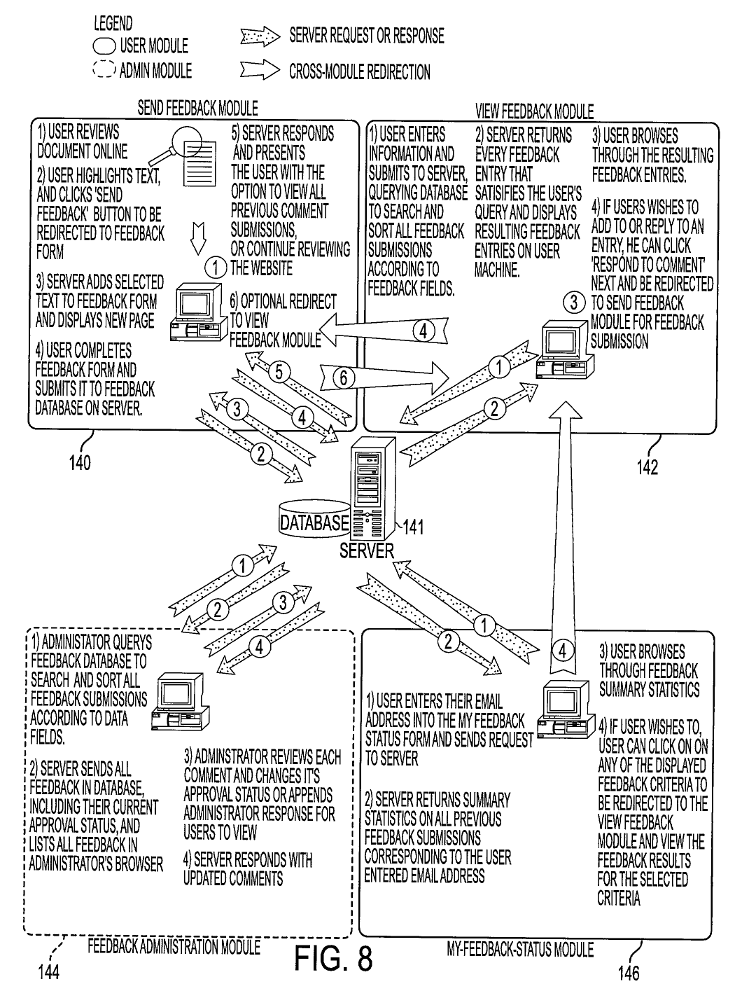

FIG. 7 shows a high-level diagram of interactions between modules in an embodiment of the present invention. FIG. 8 shows a more detailed view of the interactions shown in FIG. 7. A send feedback module 140 typically interacts with a server 141 and with a view feedback module 142. The view feedback module 142 also typically interacts with a personalized feedback module (referred to hereafter as the “my-feedback-status” module) 146. The my-feedback-status module 146 interacts with the server 141. A feedback administration module 144 also interacts with the server 141. In one embodiment, the server 141 acts as both the hypertext server 32 and the application server 35, in which case the modules 140, 142, 144, 146 reside and execute on the server 141.

With the send feedback module 140, users can send general comments or feedback concerning specific information within an online document. The view feedback module 142 allows users to search, sort, and view previous comments or submissions that are recorded in the database. The my-feedback-status module 144 lets users see the status of their own previous comment submissions, and where their comments are in the feedback process. With the feedback administration module 146, administrators are allowed to search, sort, and view all comments sent for further review, after which they are allowed to alter the approval status of the comments, delete them, or add an administrator response.

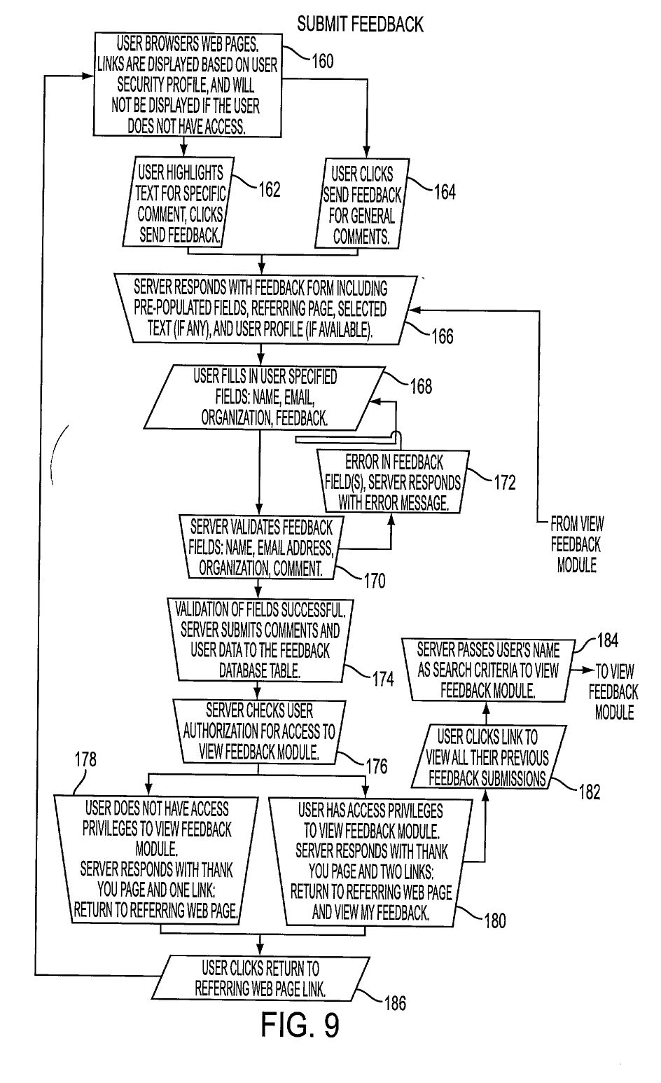

FIG. 9 shows a process flow of the send feedback module 140. The process in FIG. 9 is also one of the possible approaches to implementing the processes discussed above with reference to FIGS. 4-6. Initially, a user browses 160 a web page of the document base 34. Optionally, the browsing 160 is based on a user security profile, discussed later, which may affect what pages or documents in the document base 34 may be viewed, commented on, etc. The web page is preferably the result of the server executing a PHP script, an example of which is shown at the end of this description. While reviewing the web page, the user either highlights 162 text (or online content) for specific comment or simply clicks a feedback button or widget to enter 164 general comments. When feedback is invoked on selected content or data (e.g. text), the browser automatically captures the selected content with javascript executing in the browser. An example of suitable javascript code is included at the end of this specification. Other methods of automatically capturing the highlighted portion are possible, as for example by calling functions in a native browser application programming interface or the like. The captured portion may also be forwarded to the server with a cookie.

Following 162 or 164, the server responds 166 with a feedback form that includes pre-populated fields, a description or title of the referring page, the selected text or content (if any), and the user's profile if available. The web page containing the feedback form is preferably generated by the server executing a server-side script such as PHP. Other methods of dynamic web page generation may also be used (e.g., ASP, JSP, Cold Fusion, etc.). The user fills in 168 various other fields, including name, email address, organization, and the feedback of the user. The selected text can be pre-populated into the form by the server because it was previously automatically captured 120 by the browser (as discussed above) and sent to the server when the send-feedback request was clicked or submitted 162. The server validates 170 the feedback fields. If the fields are not correct, an error message is sent 172, and the user again fills in 168 the form. If the validation is correct, then the server stores 174 the comments and user data in feedback database 38. If the user does not have authority or access privilege to view feedback (as with the view feedback module 142, discussed below), then the server responds 178 with a simple “thank you” page possibly including a link to return to the initial commented-on web page. If the user has authority or access privilege to view feedback 176 (as with the view feedback module 142, discussed below), then responds 180 with the “thank you” page also includes a link to the view feedback module 142.

If the user clicks 182 the link to view their previous feedback submissions, then the server passes 184 the user's name or identify information as search criteria to the view feedback module 142. Otherwise, the user resumes 186 browsing the commented-on web page.

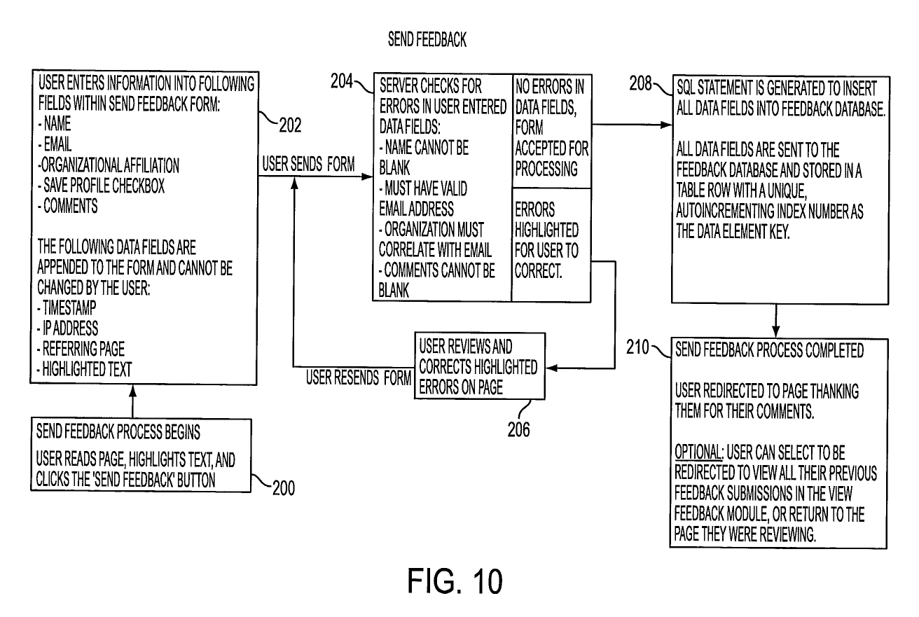

FIG. 10 shows another aspect of the process of the send feedback module 140. Again, the user selects a displayed portion and initiates 200 the feedback submission process. The feedback form preferably includes name, email, organizational affiliation, comments, and save profile fields. Additional fields can be added as needed to track other desired information about the user or feedback entry. Furthermore, the server automatically includes 202 hidden fields in the form, including a timestamp, the IP address of the browser, the referring page, and the highlighted text or selected content. The hidden fields are session variables that carry the hidden information back to the server for later use by the server. The timestamp data field is the recorded time on the server when the feedback was sent by the user. The IP address is the IP address of the user's machine on the Internet and is used to identify what machine is being used to browse and send feedback. The IP address is preferably obtained by a reverse domain name lookup, and provides for non-repudiation of the submitted feedback. The referring page data field records the page from which the user feedback originated. This information is preferably stored as a relative URL, but may be any information that identifies the web page being commented on. The highlighted text data field stores the text the user highlighted and to which the sent feedback is directed.

The validation 204 may include a language filter to prevent inappropriate language from being included in a comment. After validation 204 and correction 206 are complete, the validated form fields (both user supplied and hidden) are used by the server to generate 208 an SQL statement that will insert the form fields into the feedback database 38. Preferably, an Open Database Connectivity (ODBC) connection is established and the SQL statement is then executed to insert each user entered data field into the corresponding fields in the feedback database 38. Commonly reused pre-populated fields can also be stored at this point in the form of cookies or temporarily on the server in session variables to expedite subsequent feedback submissions. At this point, the send feedback process has completed 210.

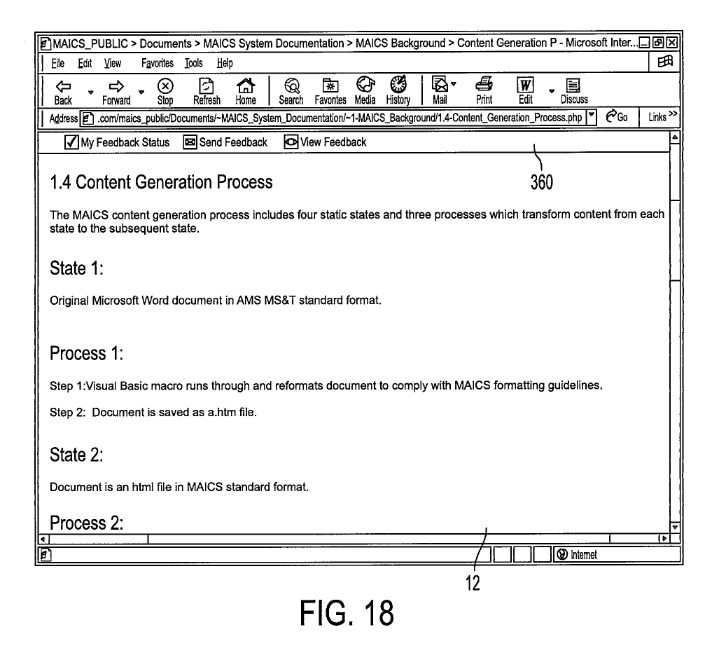

As shown in FIGS. 7-9, after completing 210 the feedback submission process 142, the user may proceed directly to the view feedback module 142. The view feedback module is also a stand-alone module that can be invoked by a user command as a result of, for example, clicking on a widget displayed in a web page or selecting an item in a pull-down menu popped up from within the web page (see widget 360 in FIG. 18).

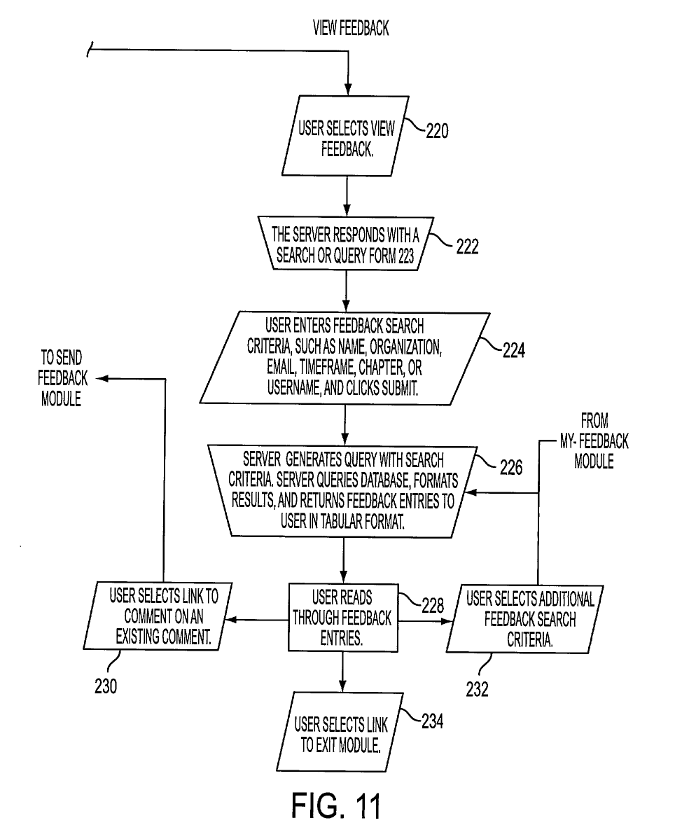

FIG. 11 shows a process of the view feedback module 142. The view feedback module 142 enables a user to view previous comment submissions. The user can search, sort, and view specific comments in the database 38 based upon several user-defined search criteria. Additionally, the user may select from several links, which act as predefined queries to search through the feedback database 38. The user may also view the default output of all feedback entries in the database 38. The view feedback module 142 is a front-end interface for the feedback database 38, and allows users to browse through, search, and sort previous feedback entries. Again, the availability of these operations for an individual user may depend upon an optional security or user profile associated with each individual user.

Initially, the user viewing a web page or document of the content or document base 34 selects 220 the view feedback option, for example by clicking on a menu item, by clicking on a “view feedback” widget, by using a keyboard shortcut/accelerator, or other mechanisms provided with the viewed web page or document by the server's view feedback module 142. The server responds 222 with a hypertext search or query form 223 (not the same as the submit feedback form 16). The user's browser receives the query form 223, and the user enters 224 feedback search criteria, such as name, organization, email, timeframe, chapter, or username, and clicks a submit button.

The server receives the submitted query form 223, generates 226 a query with the user-defined search criteria, queries the database 38 (or feedback table therein), formats the results, and returns the formatted feedback entries to the user's browser for display and browsing. The feedback entries are preferably displayed in their entirety along with hyperlinks to content or hypertext documents to which the comments were directed and associated, and as well as hyperlinks to the send feedback module 140, should the user wish to respond to a resulting feedback entry. The user browses or reads 228 the returned feedback entries. The user may then select 230 a link from one of the resulting comment submissions to add a response or comment to the submission. Selecting 230 the link redirects the user to the send feedback module 140. The user may also select 232 additional feedback search criteria to further search and filter the results from the feedback database 38, or exit 234 the search results page.

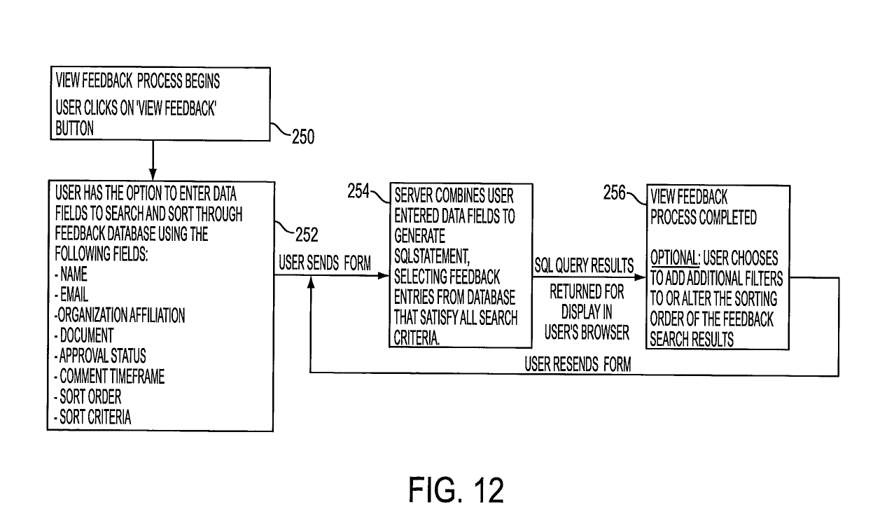

FIG. 12 shows other details of the process by which a user can view previous feedback submissions held in the feedback database 38. The user chooses 250 to view previous feedback submissions using the view feedback module. In the view feedback search form 223, the user can enter a combination of search fields including: a user name, an email address, an organization affiliation, a document, an approval status, a comment timeframe, a sort order, or sort criteria. The server then combines 254 the user-entered data fields to generate an SQL statement for selecting the feedback entries that satisfy all of the search criteria. The SQL results are returned for display, after which the user can browse through the resulting feedback entries, reading each comment, the associated context within which it was made, and optionally select a link to redirect them to the full page where the given comment was made. Should the user wish to add to, respond to, or comment on a particular one of the displayed feedback comments, then the user can click a ‘respond to comment’ link associated with the particular feedback entry. This will redirect the browser to the send feedback module 140, and the user can then enter comments on the resulting feedback entry. In the view feedback results, the user also has the option to choose 256 to add additional filters or to alter the sorting order of the search results.

In the view feedback search form, a name field is a text field in which a user can enter a whole or partial name. An email address field is a text field in which a user can enter a whole, or partial email address. An organization affiliation data field is a drop-down menu which may be dynamically generated using a server-side scripting array listing all possible organization affiliations for users reviewing documents or online content. A document field is another dynamically generated drop-down menu and lists documents or content currently available for review. The document or content menu may be dynamically created by browsing the current directory structure for documents currently available for review. Preferably, only active published documents or content will be listed. Additionally the document listing can be in accordance with a security module, only allowing users to select from documents or content they are authorized to view. A text entry field may be used if there are too many documents to list in the drop-down menu. An approval status data field is a dynamically generated drop-down menu which lists all the possible approval status levels of a feedback entry, and which may be obtained from a configuration file or the like. A comment timeframe is a text field in which a user may enter a number to limit the search results to some previous number of days. A sort order field is entered with a static drop-down menu, which gives the user the option to sort the resulting feedback entries in ascending or descending order. A sort criteria is a dynamically generated drop-down menu, which allows the user to select a specific data attribute with which to sort the feedback results.

The results of a view feedback search displayed in the browser are obtained from the feedback database 38. The feedback database 38 typically includes fields such as: the name of the feedback sender; the user's corresponding email address; the time it was sent to the database; the user's organization affiliation; the username under which they accessed the site; the referring page on which they made a comment (if this page is active on the server, a hyperlink will be dynamically generated for it); the selected text highlighted for comment; the user's comment; the approval status of the comment; and an administrator response, if one has been added. Some or all of these fields may be returned and displayed in response to a search request. Also, if there are any user additions or comments associated with a found feedback entry, they are displayed immediately under the original comment, with the most recent response listed first.

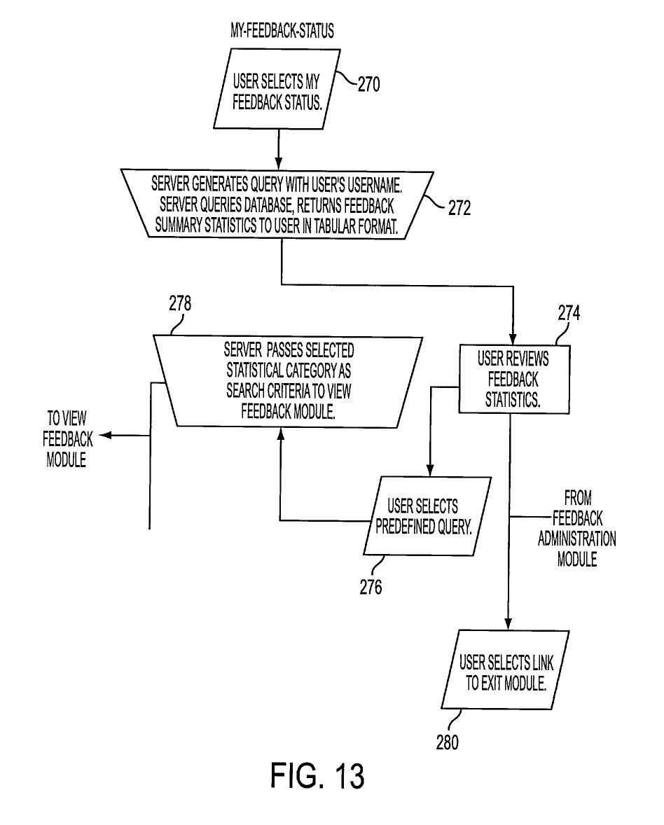

FIG. 13 shows a process of the my-feedback-status module 144. The my-feedback-status module 144 provides users with quick access to information regarding their previous comment submissions stored in the database 38. Through the my-feedback-status module 144, users can have one-click access to view their sorted comments. The user selects 270 in their browser the my-feedback-status option (see widget 360 in FIG. 18). The server generates a query with the user's username or other information identifying the user, which may be automatically sent to the server in a hidden session/state variable or in a cookie, or by a form discussed below. Accordingly, the server generates 272 a query to find feedback submitted by the user, and returns feedback information, such as the feedback comments or summary statistics of the user's feedback. The user reviews 274 their feedback, and may either exit 280 or select 276 a predefined query. If the user selects 276 a predefined query, then the server passes 278 the selected statistical category as search criteria to view feedback module 142, which generates 226 a query where the search criteria is the selected 276 predefined statistical category.

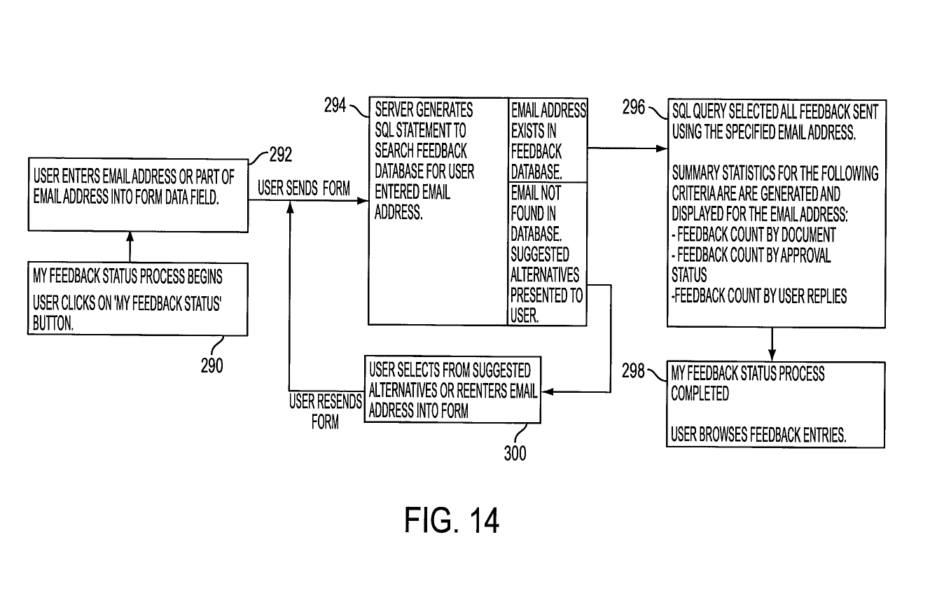

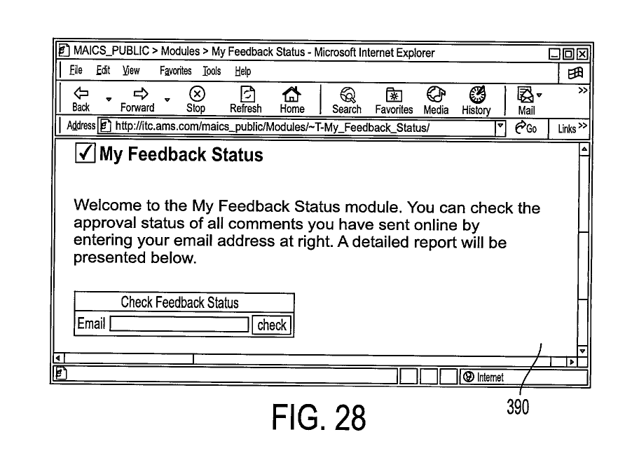

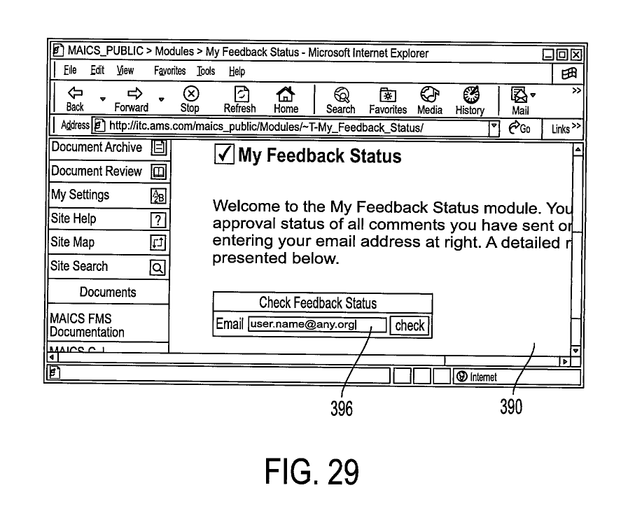

FIG. 14 shows other details of the process by which a user can get information about feedback that they previously submitted. The process begins 290 when the user clicks a “My Feedback Status” button (see widget 360 in FIG. 18). This redirects the user to a web page prompting the user to enter an email address in a text field (shown in form 390 in FIGS. 28 and 29). The user enters 292 the email address for which they are interested in viewing summary feedback statistics. Other means of identifying the user-specific feedback may be used, such as a user name or a user identifier. If a user profile is active, or if a hidden session variable or cookie identifying the user is available, then this information may be used to pre-populate the user-identifying field (email field). Alternatively, if this user-identifying information is available, the email address form may be bypassed; step 294 may occur directly after step 290. Otherwise, the user submits the email address to the server. In either case, the server generates 294 an SQL statement to search the feedback database 38 for feedback matching the email address or other user-identifying information. The SQL statement is executed to query 296 the feedback database 38.

If the email address or identified user does not have any entries in the feedback database 38, then the server notifies the user that the requested email address does not exist in the database. A second SQL statement is then created to query the database for email addresses that contain all or part of the text entered into the email data field. Should this query produce any resulting email addresses, then each email address is displayed as a suggested alternative for the user. The user may then select 300 an email address from the list of suggested alternatives, which automatically resubmits the request with the alternative email address to be used in the query generation 294.

Whether the original or alternate email address is used to generate 294 the SQL statement, the SQL statement is executed 296, and, summary feedback statistics are calculated 297. The feedback statistics include: feedback count by referring document or content; feedback count by approval status; and feedback count by user replies. A variety of other information and statistics is also possible, such as total feedback sent by the user, feedback count of unanswered comments, etc.

To calculate 297 the feedback count by referring document, the server first catalogs the active and published documents, which may be done by scanning the current directory structure. Only active published documents are cataloged. Once all active documents are cataloged, the server counts the number of feedback comments in the feedback database 30 that match each published document. Each data element within the feedback table has a referring URL data attribute, which identifies the page from which the comment originated.

After calculating 297 the statistics or other information, the results are returned as a web page to the user's web browser and displayed in tabular format, listing each document, approval status, or feedback reply approval status, alongside the number of matches found. If desired, additional feedback statistics could be generated, such as feedback per timeframe, feedback sent from different IP addresses, etc. Each resulting statistical category is included in the results page as a predefined query hyperlink which, if clicked, will redirect the user directly to the view feedback module 142 to generate 226 an SQL statement specifically for querying and viewing only the specific feedback entry corresponding to the clicked link in the my-feedback-status results page.

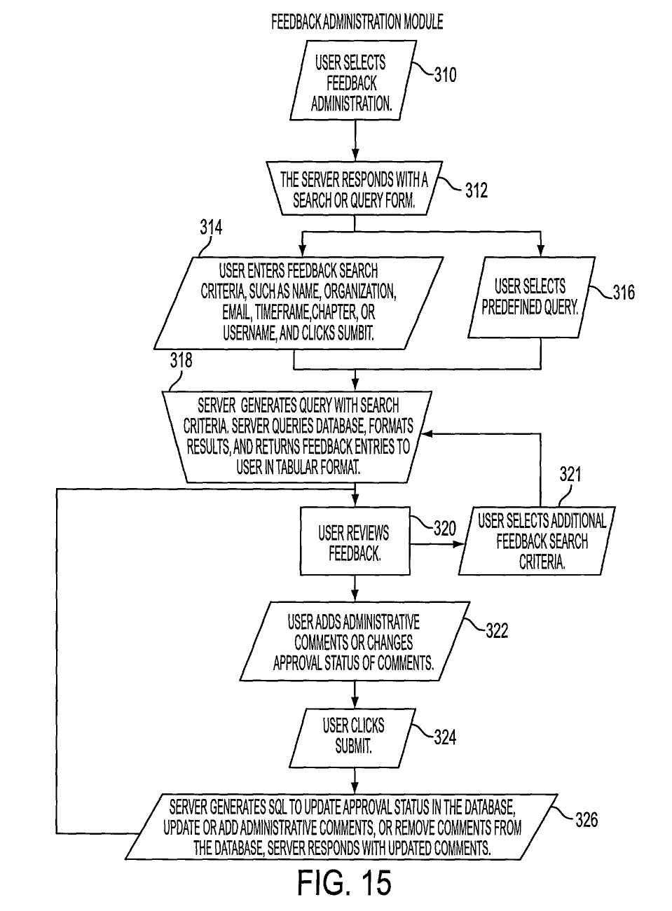

FIG. 15 shows a process carried out by the feedback administration module 146. The feedback administration module 146 is a back-end interface for managing the data stored in the feedback database 38. Preferably, access to the feedback administration module 146 is restricted to users with administrative authorization. The feedback administration module 146 allows administrators to review all feedback submissions, modify the approval status of each entry, add administrator comments to them, or logically delete them from the database 38.

As shown in FIG. 15, a user with administrative access privileges selects 310 a link to direct the user's browser to the feedback administration module. The server responds 312 with a hypertext search or query form. The user with administrative authorization either enters 314 feedback search criteria or selects 316 a predefined query. In either case, the server generates 318 a query with search criteria based on the entry 314 or selection 316. The user or administrator reviews 320 the returned feedback, and then either selects 321 additional feedback search criteria and repeats the query generation 318, or the user adds 322 administrative comments, changes approval status, or the like, and submits 324 the administrative modification. Other administrative tasks are possible, such as freezing or locking a document so no further feedback can be submitted for the document, emailing the user responsible for a feedback comment, etc. After submission 324, the server generates and executes 326 SQL to carry out the administrative action or actions, for example the change in status of a comment. The administrator then reviews the updated feedback entry returned by the server.

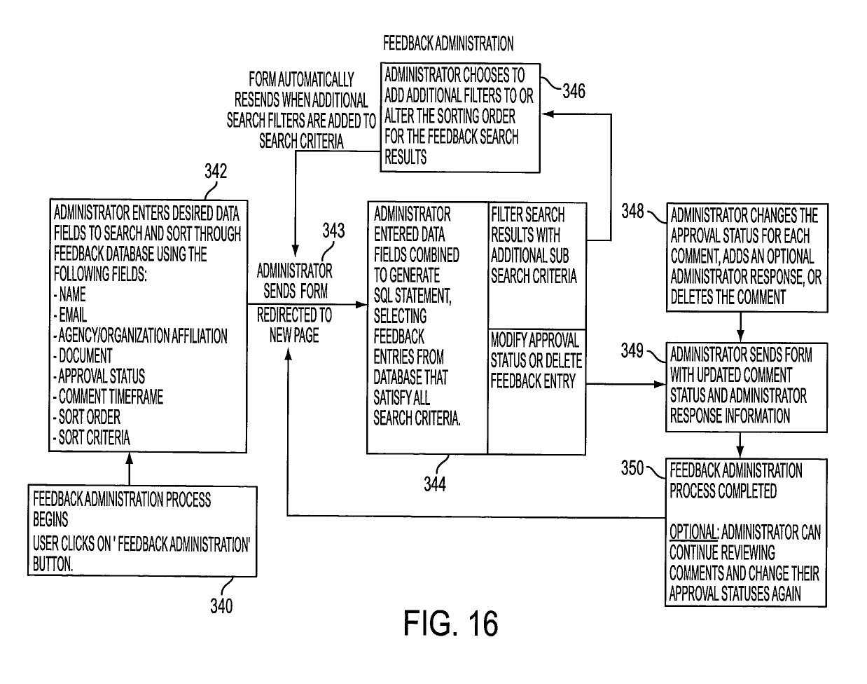

FIG. 16 shows another aspect of the process of the feedback administration module 146. The administrator or user clicks 340 a ‘Feedback Administration’ button or other administration invocation mechanism provided to the browser by the feedback system. Access to the feedback administration module 146 may be limited based on security permissions of the user.

In response to the click 340, a feedback administration search entry form is created by the server's execution of an introductory PHP script (or similar scripting language), which is part of the feedback administration module 146. The administrator may enter data in data fields, which are then used by the server to define an SQL query. If a data field is left blank by the administrator, then the module will automatically eliminate that data field as a search condition. Various data fields in the feedback database 38 can be used to tailor the search results.

The name field is a text field in which a whole or partial name can be matched to the names in the feedback database 38. The email field is a text field in which a user can enter a whole, or partial email address. The organization affiliation field is a drop-down menu, preferably generated using an array derived from a master configuration file. The menu items in the organization drop-down menu are the possible organization affiliations of users reviewing and commenting on documents. The document field is another dynamically generated drop-down menu, preferably created by scanning the current directory structure or document base 34 for documents currently available for review. The approval status data field is a drop-down menu, preferably created dynamically using an array from a master configuration file that lists all the possible approval status levels or settings. The comment timeframe is a text field in which the administrator may enter a number to limit the search results to the number of previous days.

The ‘sort order’ field is a static drop-down menu that gives the user the option to sort the resulting feedback entries in ascending or descending order. The ‘sort criteria’ field is a drop-down menu that allows the user to select a specific data attribute to sort the feedback results. The ‘sort criteria’ menu is preferably dynamically generated by sending an SQL query to the feedback database 38 to retrieve the data attribute or column names of the database 38. The resulting column or data attribute names are used to generate the ‘sort criteria’ drop-down menu.

When the administrative request search form is completed and the desired fields are filled, the user clicks ‘submit’ to send 343 the administrative request form to the server for processing. The server uses the search data entered by the administrator to generate and execute 344 an SQL statement for selecting feedback entries that satisfy the search criteria. The server then redirects the administrator's browser to a results page containing the results that the server matched to the search criteria specified by the administrator. At the top of the administrative search results page is a form with the data fields used to sort the resulting feedback entries. The current active data attribute filters used in the current sort will be displayed in the corresponding data fields. If a data field was unused in the previous sort, then it will remain blank. This form can be used to further search and sort 350 through the resulting feedback entries by adding or modifying the data fields.

The administrator may then browse 348 the search results. In the results displayed in the administrator's browser, each feedback entry displays the name of the feedback sender, the corresponding email address, the time it was sent to the database, the user's organizational affiliation, the username under which they accessed the site, the IP address from which the commentor accessed the site, the page to which the feedback comment was directed (a hyperlink to the page will be included with the results if the page is currently active on the server), the selected text highlighted for comment, the user's comment, an approval status of the comment, and any administrator responses. If there are any user additions or comments on a feedback entry, they will be displayed under the original comment, with the most recent response listed first.

Also displayed with each feedback entry are fields that the administrator can use to update 348 the search results. An approval status data field allows an administrator to modify the approval status of a feedback entry or logically delete a feedback entry. The approval status data field is a dynamically generated drop-down menu created using an array from the master configuration file, which lists all the possible approval status levels currently listed in the configuration file as well as a delete option. An administrator response data field is a text area that allows an administrator to append their comments to the feedback entry. If there are any previous administrator responses, this text area will be populated with the last comment appended by an administrator to the feedback entry. Additionally, it is possible to alter the database structure to allow all administrator responses to be saved and displayed according to which administrative user made the response and when the response was sent to the database 38.

After selecting the desired approval status and entering any an optional administrator response, the administrator sends 349 the form to the server for processing. Each feedback approval status is updated in the database 38 and the server returns all the updated feedback entries. The administrator's browser displays the updated approval status and any newly added administrator response. If the delete option was selected in the approval status data field, the feedback entry is logically deleted from the database 38 by no longer allowing the feedback entry to be publicly viewed. All comments within the database that have the associated “delete” approval status are invisible to general users with no access to the feedback administration module.

As mentioned above, the feedback system may include security features to restrict access to certain pages or content. Users may be authorized to view different pages according to their access privileges. These access privileges or permissions may be discretely apportioned to users, granting them access down to the individual document or online content level. Additionally, these user permissions may restrict or limit access to the various modules 140, 142, 144, 146 that comprise the feedback system.

A user's access privileges will define how they can interact with the feedback system, thus inherently giving them a role as a reader (one who can review online content and access the view feedback module 142 to review previous comment submissions), a reviewer (one who has reader privileges as well as the ability to access the send feedback module 140 to send comments to the database 38), or administrator (one who has reviewer privileges as well as the ability to access the feedback administration module 144 to interact with and modify all comment submissions in the feedback database 38). It is also possible to group users into types to grant them generically defined access privileges according to the user type in which they are placed.

User access rights are created, updated, and maintained within the database 38 on the server. Alternatively, an enterprise directory 40 such as Novell or Active Directory could be accessed using the Lightweight Directory Access Protocol. Each user account contains several data fields, which include unique information about the user to assist in the authentication and authorization process.

The user authentication process begins as soon as a user first accesses the site. If a new browsing session is starting, the user will be prompted for a username and password to allow system access. If the user is properly authenticated on the system, then access rights are granted to the user according to the information in their user account, which may be stored in the database 38. Information reflecting the user's proper authentication and access privileges is preferably stored for the duration of the user's browsing session in session or state variables on the server to aid in the authorization procedure. Alternatively, the user's authenticated access privileges may be stored temporarily in the user's browser using cookies.

Each time a page is requested, the authentication procedure checks against the user's authentication information to ensure that the user has access privileges for that page. Additionally, the authorization procedure will check, prior to the dynamic generation of navigation menus and links throughout the feedback-enabled site, to ensure the user has access to the page being linked to. A link or menu item will not be displayed if the user does not have access privileges to the page or content linked to by the link or menu item. Should the user directly access a page or content to which they do not have access privileges, the server-side script responsible for authorization will print out a short sentence informing them they do not have access rights to the requested page.

User Interaction and Interface

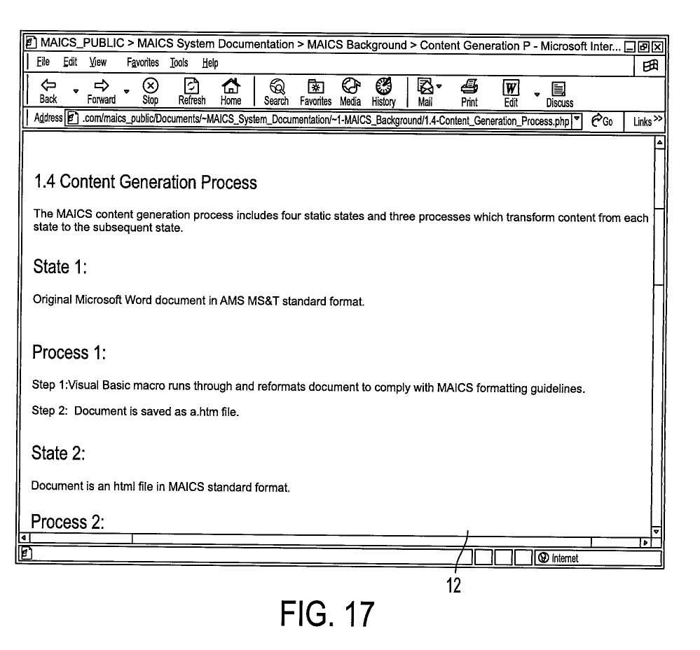

FIGS. 1-6 were referred to above in describing an overall process of the present invention. FIGS. 7-16 were referred to above in describing a modular aspect of the present invention. FIGS. 17-31 are referred to below in describing user interaction with the feedback system and its modules.

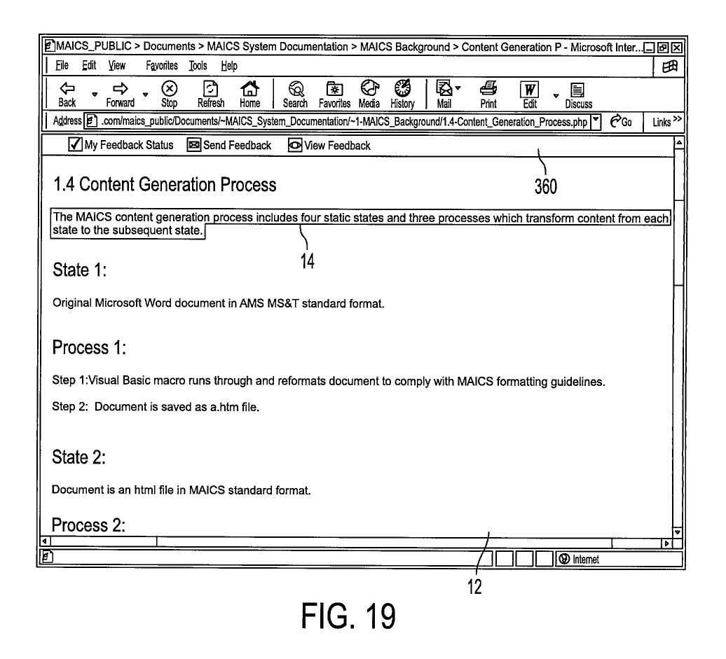

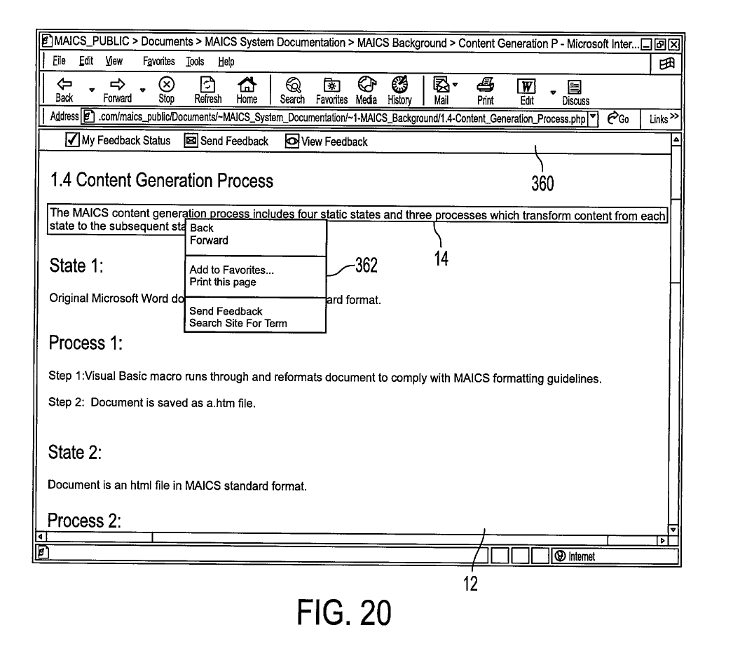

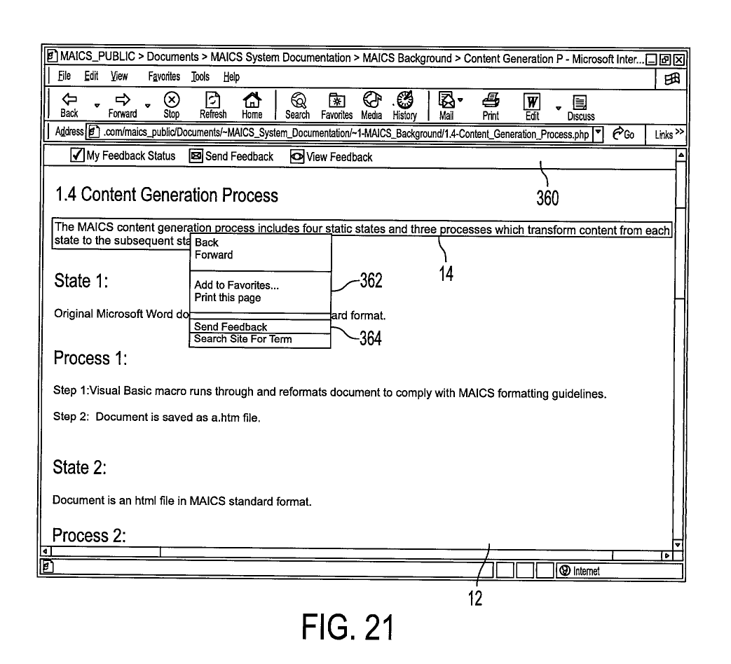

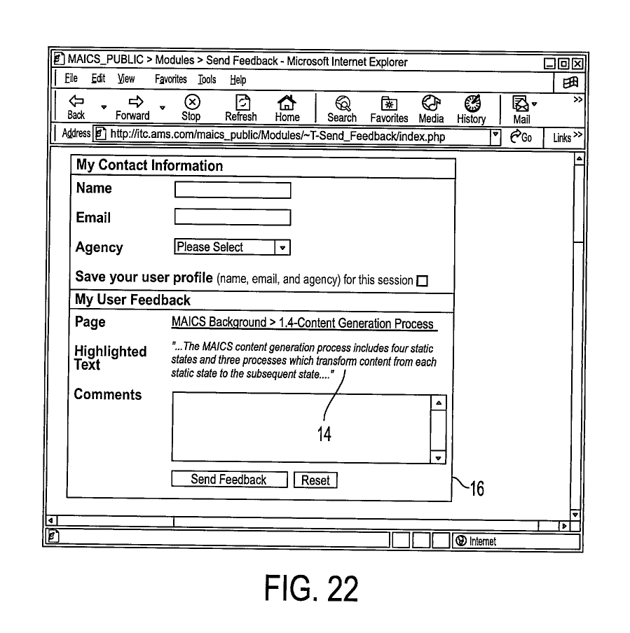

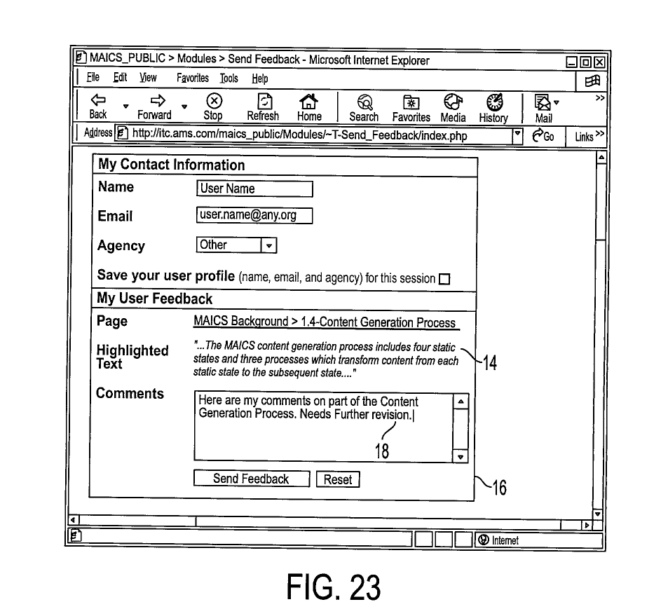

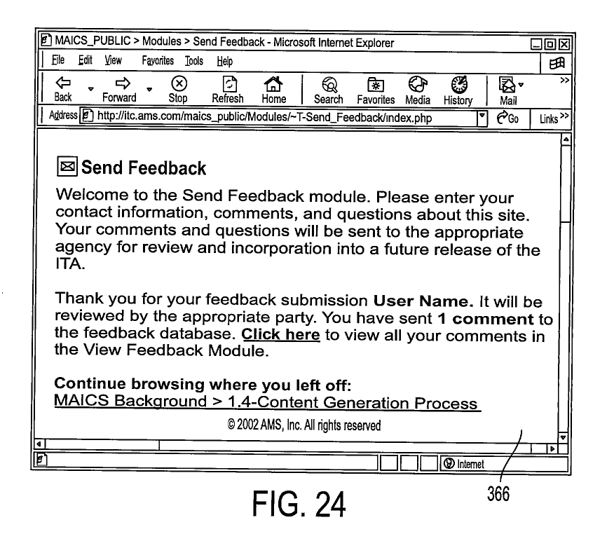

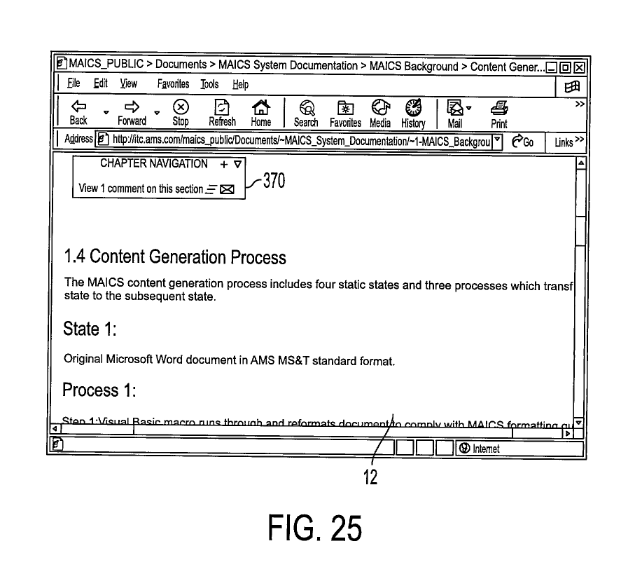

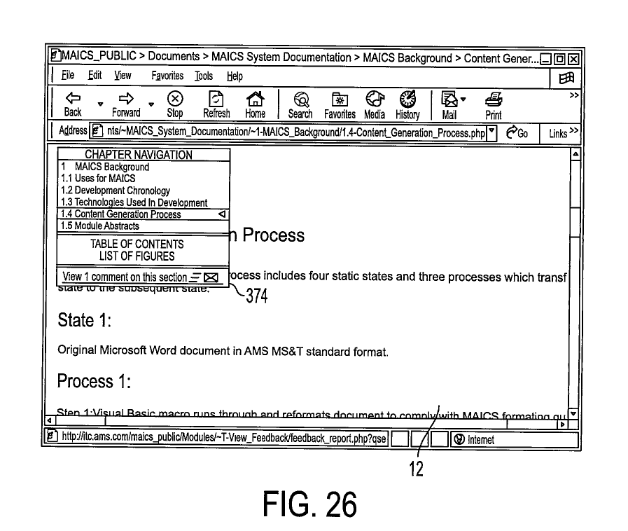

FIGS. 17-25 show user interface screens for entering feedback. FIG. 17 shows a simple document 12 from the document base 34 as it would be displayed without the feedback system. FIG. 18 shows the document 12 as displayed in the feedback system. The feedback system adds the interface objects 360 in accordance with the user's access privileges. FIG. 19 shows a portion of the document 14 that has been highlighted by the user. FIG. 20 shows a menu 362 popped up by, for example, right clicking on the document 12. Alternative methods of displaying the menu are possible, such as popping up a menu once a user has completed highlighting some content. FIG. 21 shows the “Send Feedback” menu item 364 being selected to initiate the send feedback process. FIG. 22 shows the submit feedback form 16 in which the selected text 14 has been automatically incorporated. FIG. 23 shows data entered in the submit feedback form 16, including the feedback comment 18. FIG. 24 shows a page 366 displayed in response to the successful submission of the form 16 shown in FIG. 24. FIG. 25 shows the commented-on document 12 and a “view comments” widget 370. When the document 12 in the document base 34 is viewed, the feedback system automatically supplements the hypertext being sent to the browser with the “view comments” widget 370. The “view comments” widget 370 is only added or displayed when there are feedback comments in the database 38 that are associated with the document 12. FIG. 26 shows a pull-down menu 374. The pull-down menu 374 is another way of issuing a “view comments” command. The menu 374 may be activated by passing the pointer over the “Chapter Navigation” box.

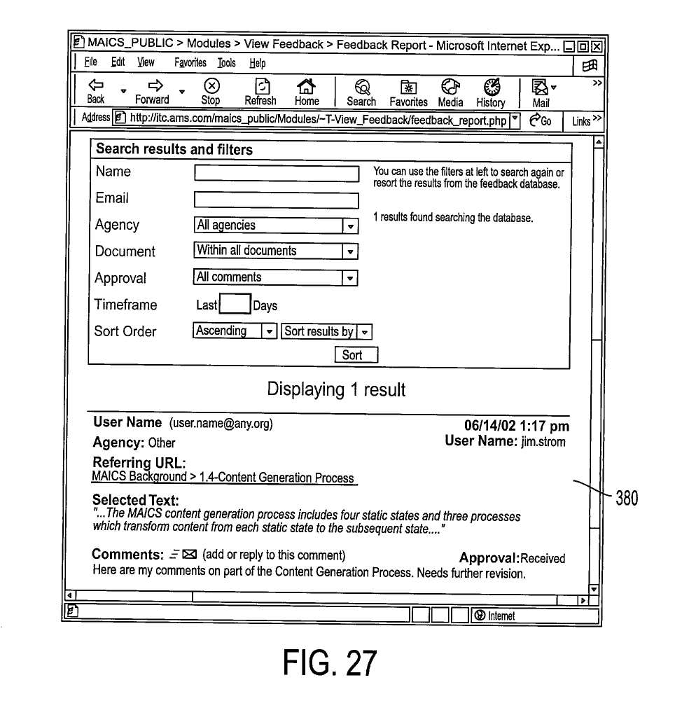

The “view comments” widget activates a predefined query that will be directed through the view feedback module 142 to select and display feedback entries that originated on the page being viewed. When the “view comments” widget is selected, the user is redirected to the view feedback module 142 and a search for comments that originated on that page is automatically processed using the predefined SQL query. FIG. 27 shows a page 380 displayed in response to a user clicking on the “view comments” widget contained within a specific page.

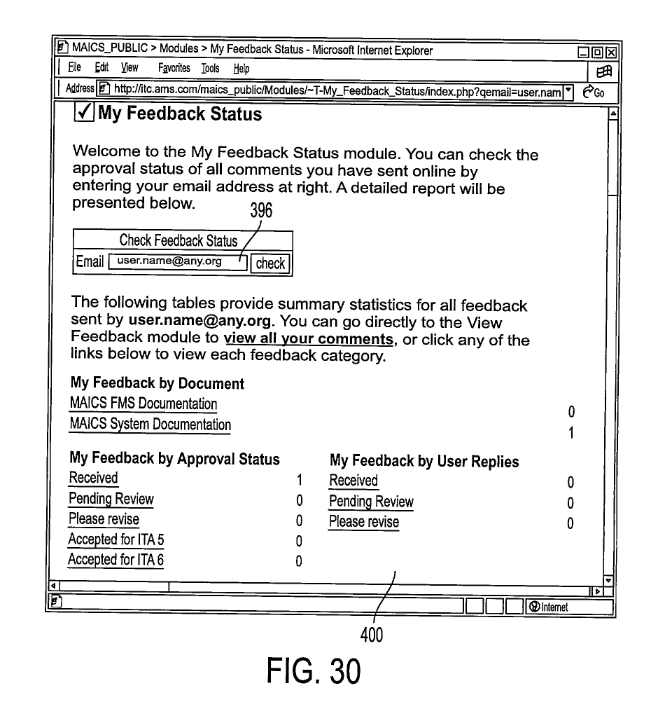

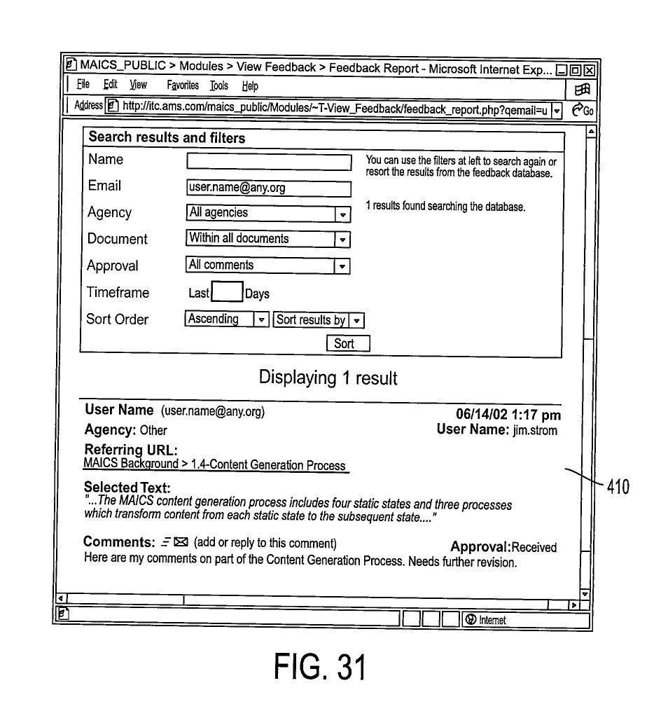

FIG. 28 shows an example of a “my feedback” form 390 used to enter 292 the email address of the user. FIG. 29 shows an email address entered in the form 390. FIG. 30 shows a search result page 400 returned after submitting the “my feedback” form 390. FIG. 31 shows an example of a “view feedback” result page 410 resulting from a “view feedback” search 254.

Feedback System Mirroring

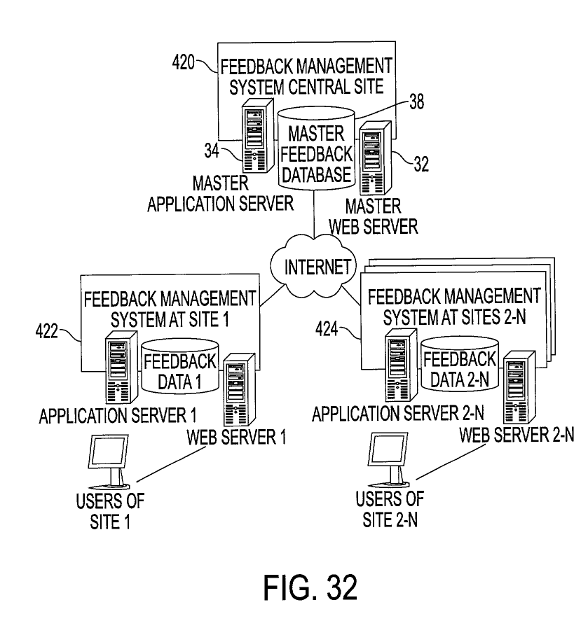

FIG. 32 shows a feedback mirroring arrangement. The feedback management system generally includes a database server 38, an application server 35, a web server 32, a connection to the Internet 30, and some form of content for review, such as document base 34. The feedback system can be installed at multiple sites, each with its own set of application, database, and web servers. If public comment was necessary on a new piece of legislation and various special interest groups were required to submit comments, then each of the special interest groups could host a copy of feedback management system in conjunction with a web based version of the legislation. With the feedback management system installed independently on each special interest group website, members of these groups could provide password protected comments on the legislation. At the end of the public review and feedback time period, each separate installation of the feedback system would contain different comments from different people. Building a central repository of all comments would require simple database replication. Each feedback management system installation would communicate with the master database and copy the comments.

Multi-site hosting and replication can be implemented with multiple copies of the feedback management system. Data can be replicated over the Internet, copied to a CD, or otherwise transferred from the individual databases to a central location. FIG. 32 how this might work for N separate versions of the feedback system with users commenting on documents across multiple physical locations. The master central site 420 is eventually synchronized with sites 422, 424.

Once replication from each site 422, 424 to the master site 420 is complete, the master 420 would contain all feedback for the content in review. In the central location 420, the application server 35 and database 38 would provide reporting, comment consolidation, and password or role based viewing facilities for interested parties, such as legislative committees. The methods used to transfer comments from the individual feedback management system installations 422, 424 to the central comment repository 420 could be one of a number of standard database administrative or application level functions. Such replication or transfer methods could use any number of industry standard interfaces such as XML, ODBC, or JDBC, and could occur once, or periodically.

Exemplary Source Code

The following is sample javascript code that may be used for automatically capturing the highlighted selection or portion of online content:

```
function set_variables(formName) {
  if (document.getSelection) //for IE4 or higher
    newText = document.getSelection();
  else if (document.selection) //for NS4 or higher
    newText = document.selection.createRange().text;
  else return;
  /* Go through each form name within the page. If the variable
    formName passed by the user matches the name of the form in
    documents.forms[i].name, then that is the form we are looking for.
    This form will have the hidden variable we need to change. */
  for (i=0;i<document.forms.length;i++) {
    if (formName == document.forms[i].name) {
      var form = document.forms[i]
        }
  }
  /* Finally, change the hidden form field within the form we found above
    to the user's highlighted text. */
  form.selectedText.value = newText;
}
```

The javascript function above will take the content a user highlights in the browser window and set a hidden variable within the feedback form equal to that content. The process is initiated when the user highlights some content. There are currently two ways in which the user can set the hidden field within the feedback form. Once the content has been highlighted, the user can roll over the ‘Send Feedback’ link in the top or left menu (see FIGS. 25 and 26). This action will call the above-mentioned javascript function to set the hidden field in the feedback form equal to the content that was highlighted. The second method is to activate the right-click menu. As soon as the user rolls over one of the menu options, this function is called and the hidden field is set to the highlighted content. Slightly different syntactical code needs to be used for different browsers to comply with their BOMs (browser object model), allowing the feedback system to temporarily store the user highlighted text in a JavaScript variable, “newText”. This variable will be used later to change the hidden variable within the feedback form.

The following is an example of a PHP server-side script of the type that can be used in the send feedback module 140:

```
<?php
/* This is the Send Feedback module which will check the feedback form for errors
  If no errors are found, the script will process the form, generate a SQL
  query and insert the data fields into the database */
$path = “../../”; // this is the relative path to the root directory
// include the header template
include($path.“includes/header.php”);
/* If the user has previously saved their profile, retrieve those values and
  use them to autopopulate the fields */
if(@$_SESSION[‘userProfile’]) {
  $explode = explode(“##”, $_SESSION[‘userProfile’]);
  $name = $explode[0];
  $email = $explode[1];
  $agency = $explode[2];
}
// initialize the errors array and the array of data fields to check
  $errors = array();
  $fields = array(“name”, “email”, “agency”, “comments”);
  /* If the form is submitted, test the data fields for errors. Each time
    there is an error found, add the error to the errors array, which will
    printed out to alert the user */
  if (@$submit) {
    while (list($Index,$Value) = each($fields)) {
      if (@$$Value == “”) array_push($errors, ucwords($Value).“
    cannot be blank”);
    }
    emailcheck($email);
  }
  /* If the form is submitted and there are no errors in the data fields, go
    ahead and process the form */
  if (@$submit && !@$errors) {
    /* Define which table the feedback entry will be placed in. The variable $F
      will exist if the user is redirected to this page by adding a response
      to an existing comment in the database. If this is the case, then the
      user's comment will be inserted into the FeedbackReplies table. If the
      user enters ‘error’ into the name field, the feedback will be inserted
      into the ErrorLog. */
    if (@$F) $table = “FeedbackReplies”;
    elseif($name == “error”) $table = “ErrorLog”;
    else $table = “Feedback”;
    $timestamp = time();
    $referringURL = eregi_replace(“/$config[site]/”, “”,
    clean_entry($referringURL));
    // Generate the SQL query that will insert all data fields into the
    database
    $SQL_insert = “INSERT INTO $table
            (userIP, username, name, email, agency, referring,
            SelectedText, comments, SubmitTimeStamp, sessionID)
            VALUES (‘$REMOTE_ADDR’,
            ‘$_SESSION[authenticated_user]’,
            ‘$name’,
            ‘$email’,
            ‘$agency’,
            ‘$referringURL’,
            ‘$selectedText’,
            ‘$comments’,
            ‘$timestamp’,
            ‘$PHPSESSID’)”;
    // uncomment this section if you wish to print and check the query
    //echo $SQL_insert;
    if (!($insert = odbc_exec($db, $SQL_insert)))
    die (“Cannot insert feedback”);
    /* All data has been successfully inserted in the database at this point.
      The user will be thanked for their comment with a personalized response. */
    echo “Thank you for your feedback submission <b>$name</b>. It will be
      reviewed by the appropriate party.”;
    if (file_exists(“Modules/˜T-View_Feedback/feedback_report.php”))
      $view_link = $path.“Modules/˜T-
  View_Feedback/feedback_report.php?qname=$name&qemail=$email”;
    elseif (file_exists(“Modules/˜L-View_Feedback/
    feedback_report.php”))
      $view_link = $path.“Modules/˜L-
  View_Feedback/feedback_report.php?qname=$name&qemail=$email”;
    /* If the user has access to the View Feedback module, and the View Feedback
    module is active on the server, print out a count of all the user's previous
    feedback entries and provide them with a link to view all previous entries */
    if (eregi(“View_Feedback”, $_SESSION[‘Modules’]) &
    & @$view_link) {
      $SQL_count = “SELECT COUNT(*) FROM $table WHERE name =
      ‘$name’AND email
  =‘$email’”;
      if (!($count = odbc_exec($db, $SQL_count))) die(“Cannot execute
      count”);
      $count = odbc_result($count, 1);
      if ($count == 1) $count = “$count comment”;
      else $count = “$count comments”;
      echo “You have sent <b>$count</b> to the feedback database.
        <a href=‘$view_link’ class=‘Links’>Click here</a>to
        view all your comments in the View Feedback module.”;
    }
    /* If the user commented on a page within a document, print out a link for
      the user to continue browsing where they left off. Eventually a link to
      continue browsing feedback where the user left off will be included in
      here as a potential option. */
    if (!@$F) {
      $back = CleanName(basename(dirname($referringURL)).“>
  ”.basename($referringURL));
      echo “<p><b>Continue browsing where you left off:</b><br>
        <a href=‘$path$referringURL’ class=‘Links’>$back</a></p>”;
    }
    // register the user profile session variable if user checks the box
    if (@$saveProfile) {
      $_SESSION[‘userProfile’] = “$name##$email##$agency”;
    }
    // delete any existing user profile session variable if user unchecks the
    box
    else {
      session_unregister(“userProfile”);
    }
  }
  /* If errors are present in the form, or the user is accessing the page for the
    first time, print this form and table out. */
  else {
    // print out the errors if they exist
    while (list($Index,$Value) = each($errors)) {
      echo “<li><span style=‘color:#FF0000’>$Value</span>”;
    }
  ?>
    <form method=“post” action=“index.php” name=“form”>
    <table width=“400” border=“0” cellspacing=“0” cellpadding=“5” class=“calloutTable”>
      <tr align=“left” valign=“middle”>
      <td class=“tableHeader” colspan=“3”>My Contact Information</td>
      </tr>
      <tr align=“left” valign=“middle”>
      <td><b>Name</b></td>
      <td>
      <input type=“text” name=“name” size=“20” value=“<?=@$name?>”
  class=“searchForm”
        onFocus=“bgChange()” onBlur=“bgChangeBack()” style=“width:150”>
      </td>
    </tr>
    <tr align=“left” valign=“middle”>
      <td><b>Email</b></td>
      <td>
      <input type=‘text’ name=‘email’ size=‘20’ value=‘<?=@
      $email?>’ class=‘searchForm’
        onFocus=‘bgChange()’ onBlur=‘bgChangeBack()’ style=‘width:150’>
      </td>
    </tr>
    <tr align=“left” valign=“middle”>
    <td><b>Agency</b></td>
    <td>
      <select name=“agency” class=‘searchForm’
      onFocus=‘bgChange()’ onBlur=‘bgChangeBack()’>”;>
        <option value=“”>Please Select</option>
        <?php
        sort($config[‘agencies’]);
        while(list($lndex,$Value) = each($config[‘agencies’])) {
          $selected = “”;
          if (@$agency == $Value) {$selected = “selected”;}
          echo “<option$selected>$Value</option>\r\t”;
        }
    ?>
  </select>
  </td>
  </tr>
  <tr align=‘left’ valign=‘middle’>
  <td valign=‘bottom’ colspan=3>
    <b>Save your user profile</b> (name, email, and agency) for this session
    <?php
    if (@$_SESSION[‘userProfile’])
    echo “<input type=‘checkbox’ name=‘saveProfile’ checked>”;
    else
    echo “<input type=‘checkbox’ name=‘saveProfile’>”;
  ?>
  </td>
  </tr>
  <tr align=“left” valign=“middle”>
  <td class=“tableHeader” colspan=“3”>My User Feedback</td>
  </tr>
  <tr>
  <?
  /* If the user is sending feedback on a previous feedback submission,
    change the referringURL to list the comment number, name of previous
    commentor, and the time the comment was sent. Change the selected text
    to list the previous feedback entry so the user may read the comment or
    the context of the comment in question to facilitate their own feedback
    writing. */
  if (@$F) {
    $query = “SELECT name,comments,SubmitTimeStamp FROM Feedback WHERE
index = $F”;
    if(!($execute = odbc_exec($db,$query))) die(“Cannot execute query”);
    $name = odbc_result($execute,1);
    $selectedText = odbc_result($execute,2);
    $timestamp = odbc_result($execute,3);
            $referring_display = “<span style=‘color:#FF0000’>Comment #$F by $name
                    (sent“.date(“m/d/y G:i”, $timestamp).”)</span>”;
            $referringURL = $F;
            $F = ”<input type=‘hidden’ name=‘F’ Value=‘$F’>”;
          }
          else {
            $referring_display = ‘<a href=“javascript:history.back()” class=“Links”>’
                    .CleanName(basename(dirname($referringURL))
                    .“>”.basename($referringURL)).‘</a >’;
          }
          ?>
          <td valign=“middle”><b>Page</b></td>
          <td valign=“middle” colspan=“2”>
          <input type=“hidden” name=“referringURL” value=“<?=@$referringURL?>”>
          <?=$referring_display?>
          <?=@$F?>
        </td>
        </tr>
        <tr>
        <?
        // format the selected text or previous comment
        if (!@$selectedText) {
          $print_text = “<span style=‘color:#FF0000’>You are sending general
        comments</span>”;
        }
        else {
        $print_text = “<i>\” . . . “.clean(trim($selectedText)).” . . . \“</i>”;
        }
        ?>
        <td valign=“middle”><b>Highlighted Text</b></td>
        <td valign=“middle” colspan=“2”><?=$print_text?>
        <input type=“hidden” name=“selectedText” value=“<?=$selectedText?>”>
    </td>
    </tr>
    <tr align=“left” valign=“middle”>
    <td valign=“top”><b>Comments</b></td>
    <td width=“80%” colspan=2>
    <textarea style=“width:100%” name=“comments” cols=“50” rows=“6”
    onFocus=‘bgChange()’ onBlur=‘bgChangeBack()’><?=@$comments?></textarea>
    </td>
    </tr>
    <tr>
    <td>&nbsp;</td>
    <td colspan=“2”>
    <?
    if (@$F) $send = “Response”;
    else $send = “Feedback”;
    ?>
    <input type=“Submit” name=“submit” value=“Send<?=$send?>”
  class=“search Form”>&nbsp;
    <input type=“Reset” name=“reset” value=“Reset” class=“searchForm”>
    </td>
    </tr>
  </table>
  </form>
  <?php
  } // end the else clause
  // include the footer template
  include(“./includes/footer.htm”);
          ?>
```

Conclusion

The system also includes permanent or removable storage, such as magnetic and optical discs, RAM, ROM, etc. (typical parts of any of the servers discussed above) on which the process and data structures of the present invention can be stored and distributed. The processes can also be distributed via, for example, downloading over a network such as the Internet.

The present invention has been described with respect to a system for feedback submission and management. Although reference has been made to providing feedback to browsable online content, hypertext documents, web pages, and the like, it will be appreciated that the invention is not limited strictly to HTML or hypertext-type content. The invention is applicable to all forms of online browsable content, where “content” is defined to include at least hypertext, HTML, hypercontent, non-text or binary media, and other content that is received over a network for browsing, and which may include hyperlinks to other content. The modular architecture is beneficial but not required. The term “browser” is defined to include hypertext browsers (e.g. Internet Explorer), as well as any software or devices for browsing online content.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
allowing a user to interactively select a sub-portion of content displayed in a browser; and
automatically associating the sub-portion with a feedback comment submitted with the browser.

2. A method according to claim 1, further comprising storing, separate from the content, information reflective of the automatic association.

3. A method, comprising:
enabling a user to interactively select a sub-portion of a document stored at a network location remote from the user;
enabling the user to locally submit a feedback comment directed to the sub-portion;
automatically creating an association between the sub-portion and the feedback comment; and
automatically storing the association at the remote network location and separate from the document.

4. A method, comprising:
enabling a user to interactively select or highlight a portion of content displayed in a browser;
enabling the user to interactively request the browser to accept feedback from the user while the portion is still selected or highlighted; and
in response to the request, automatically capturing in the browser the selected portion or information identifying the selected portion.

5. A method according to claim 4, further comprising storing, apart from the content, feedback entered by the user at the browser and associated with the automatically captured portion.

6. A method, comprising:
enabling a user to interactively select a portion of content displayed in a browser;
interactively inputting feedback related to the portion; and
automatically storing, apart from the content, information associating the feedback with the selected portion.

7. A method according to claim 6, further comprising based on the information associating the feedback with the selected portion, indicating at the browser that the original content has related feedback.

8. A method according to claim 7, further comprising while the browser is indicating that there is feedback related to the original content, requesting the browser to display the feedback.

9. A method according to claim 8, further comprising in response to requesting the browser to display the feedback, displaying the feedback, selecting at least a portion of the feedback for further feedback input and storage.

10. A method, comprising:
interactively selecting a portion of online content received over a network and being displayed in a browser;
interactively inputting feedback related to the portion at the browser; and
automatically storing, over the network and apart from the content, information associating the feedback with the selected portion of the content.

11. A method according to claim 10, further comprising:
requesting and receiving at the browser content for submitting feedback to the selected portion of the original content; and
submitting and sending the feedback across the network for storage in association with the stored selected portion.

12. A method according to claim 11, further comprising:
again receiving over the network the original content together with new information that is based on the association between the original content and the feedback; and
based on the new information, indicating at the browser that the original content has related feedback, while displaying the original content.

13. A method according to claim 12, further comprising after the browser has indicated that there is feedback related to the original content, interacting with the browser displaying the original content to cause the browser to display the feedback.

14. A method, comprising:
interactively selecting a portion of original content received over a network and displayed in a browser;
displaying at the browser a feedback form;
inputting feedback into the feedback form; and
automatically storing over the network an association between the inputted feedback and the selected portion.

15. A method according to claim 14, further comprising:
receiving over the network the original content together with new information that is based on the association between the original content and the feedback;
displaying in the browser the original content together with a feedback widget based on the new information, where the displayed feedback widget indicates that feedback relating to the original content has been submitted; and
interacting with the feedback widget to cause the browser to receive and display content that includes at least the selected portion and the feedback.

16. A method, comprising:
interactively selecting a portion of original content received over a network and displayed in a browser;
displaying at the browser a feedback form for inputting feedback while also displaying the selected portion of the original content, where the feedback form is received over the network by the browser;
inputting, from the user into to the browser displaying the feedback form, feedback relating to the original content;
submitting the inputted feedback form across the network where a receiving side can store the inputted feedback with the original content.

17. A method, comprising:
receiving over a network from a server original hypertext, and displaying the original hypertext in a hypertext browser;
selecting a portion of the displayed original hypertext by interactively and graphically highlighting the portion; and
while the original hypertext is being displayed and while the portion is selected, interactively commanding the hypertext browser to initiate a feedback process for providing to the hypertext browser feedback specifically directed to the selected portion;

18. A method according to claim 17, further comprising:
in response to commanding the hypertext browser to initiate the feedback process, receiving over the network from the server and displaying at the hypertext browser further hypertext for inputting feedback specific to the selected portion of the original hypertext, where a copy of the selected portion has been automatically displayed with the further hypertext;
while the hypertext browser is displaying the further hypertext and the copy of the selected portion, inputting from the user to the hypertext browser feedback specific to the selected portion of the original hypertext; and
submitting the feedback across the network to the server, where information associating the inputted feedback and the selected portion is established/stored.

19. A method according to claim 18, further comprising:
receiving over the network the original hypertext together with new information that is based on the association between the original hypertext and the feedback; and
displaying in the hypertext browser the original hypertext together with a feedback widget based on the new information, where the displayed feedback widget indicates that feedback relating to the original hypertext has been submitted.

20. A method according to claim 19, further comprising:
interacting with the feedback widget to cause the hypertext browser to receive and display hypertext that includes at least the selected portion and the feedback, where the selected portion and the feedback may be selected as the portion to which feedback may be directed.

21. A feedback system for adding feedback functionality to an online content management system, the feedback system comprising:
a send feedback module capable of providing the content management system with information enabling a browser displaying hypertext received from the content management system to select text for specific commenting, providing a feedback form when a portion of the hypertext is highlighted, and storing the selected text along with feedback received with the feedback form after it is returned by the browser.

22. A system according to claim 21, wherein the system is capable of being used with pre-existing web content managed by the online content management system without altering the pre-existing web content.

23. A system according to claim 22, further comprising at least one of a personalized feedback status module, a view feedback module, and a feedback management module, wherein
the personalized feedback status module, if included, is capable of:
responding to a user request to view feedback submitted by a user by searching the stored feedback for feedback submitted by the user;
sending results of the searching to the browser; and
sending a first feedback in the results to the browser for being commented on by the send feedback module, in response to interactive selection at the browser of the first feedback from among the results;
the view feedback module, if included, is capable of:
responding to a command from the browser to view feedback stored in the feedback system by sending a search form to the browser, in which a user can enter or select search criteria;
responding to return of the search form by using the search criteria to search the feedback stored in the feedback system according to the search criteria;
sending feedback matched by the search to the browser;
sending a selected matched feedback to the browser for being commented on by the send feedback module; and wherein
the feedback management module, if included, is capable of enabling an administrator to use a browser to at least one review, comment on, and change a status of feedback stored by the feedback management system.

24. A feedback system for adding feedback functionality to an online content management system, the feedback system comprising:
a send feedback module capable of providing the content management system with information enabling a browser displaying hypertext received from the content management system to select text for specific commenting, providing a feedback form when a portion of the hypertext is highlighted, and storing the selected text along with feedback received with the feedback form after it is returned by the browser, wherein the feedback system is capable of being used with pre-existing web content managed by the online content management system without altering the pre-existing web content; and
at least one of a personalized feedback status module, a view feedback module, and a feedback management module, wherein
the personalized feedback status module, if included, is capable of:
responding to a user request to view feedback submitted by a user by searching the stored feedback for feedback submitted by the user;
sending results of the searching to the browser; and
sending a first feedback in the results to the browser for being commented on by the send feedback module, in response to interactive selection at the browser of the first feedback from among the results;
the view feedback module, if included, is capable of:
responding to a command from the browser to view feedback stored in the feedback system by sending a search form to the browser, in which a user can enter or select search criteria;
responding to return of the search form by using the search criteria to search the feedback stored in the feedback system according to the search criteria;
sending feedback matched by the search to the browser;
sending a selected matched feedback to the browser for being commented on by the send feedback module; and wherein
the feedback management module, if included, is capable of enabling an administrator to use a browser to at least one review, comment on, and change a status of feedback stored by the feedback management system.

25. A distributed feedback system, comprising:
a central content repository providing content for online viewing;
a central feedback database storing comments directed to the central content repository;
one or more remote copies of the content repository, available for online viewing separate from the central content repository; and
one or more remote feedback databases storing remote feedback comments directed to the remote copies of the content repository, where the central feedback database is updated to include the remote feedback comments.

26. A computer-readable storage medium storing a program for:
interactively selecting or highlighting a portion of content displayed in a browser;
interactively requesting the browser to accept feedback from a user while the portion is still selected or highlighted; and
in response to the requesting, automatically capturing in the browser the selected portion or information identifying the selected portion.

27. A medium according to claim 26, wherein:
based on the information associating the feedback with the selected portion, the program indicates at the browser that the original content has related feedback.

28. A medium according to claim 27, wherein the process further comprises:
while the browser is indicating that there is feedback related to the original content, requesting the browser to display the feedback.

29. A medium according to claim 28, wherein the process further comprises:
in response to requesting the browser to display the feedback, displaying the feedback, selecting at least a portion of the feedback for further feedback input and storage.

30. A display displaying a user selected portion of a document and a comment concerning the selected portion having been linked to the selected portion.

31. A web page for display in a browser, comprising a portion of a previously displayed web page, the portion having been automatically included in the web page for display in a browser based upon its having been in a selection state that was set by interactively demarcating an area of the previously displayed web page containing the portion.

32. A web page for display as recited in claim 31, further comprising an area for entering a comment directed to the automatically include portion.

33. A computer readable storage containing a data structure for controlling a computer, comprising:
a user selected portion of a document; and
a comment concerning the selected portion having a link to the selected portion.
